(19) United States
(12) Patent Application Publication
(10) Pub. No.: US 2020/0088105 A1
(43) Pub. Date: Mar. 19, 2020

(54) GAS TURBINE ENGINE FOR AN AIRCRAFT WITH AN ENGINE SHAFT

(71) Applicant: Rolls-Royce Deutschland Ltd & Co KG, Blankenfelde-Mahlow (DE)

(72) Inventors: Gideon Daniel VENTER, Berlin (DE); Marcus MERDER, Potsdam (DE)

(21) Appl. No.: 16/552,638

(22) Filed: Aug. 27, 2019

(30) Foreign Application Priority Data
Sep. 19, 2018 (DE) 10 2018 123 061.3

(51) Int. Cl. F02C 7/36; B64D 27/10; F02C 7/32

(52) U.S. Cl. CPC F02C 7/36; F02C 7/32; B64D 27/10

(57) ABSTRACT

A gas turbine engine for an aircraft with an engine shaft which is in operative connection with auxiliary units. The operative connection includes interengaging gear wheels. At least one gear wheel of the operative connection is configured as a beveloid gear wheel.

This application claims priority to German Patent Application DE102018123061.3 filed Sep. 19, 2018, the entirety of which is incorporated by reference herein.

The present disclosure relates to a gas turbine engine for an aircraft with an engine shaft which is in operative connection with auxiliary units.

In the case of gas turbine engines for aircraft that are known from practice, so-called auxiliary units or auxiliary power units, such as a fuel pump, a generator and the like, are driven from an engine shaft at a respectively required level of rotational speed and torque. Provided for this is a corresponding operative connection between the auxiliary units and the engine shaft, which includes inter alia interengaging gear wheels. Some of the gear wheels are respectively connected to a drive shaft of an auxiliary unit for rotation therewith and form a so-called external gear box or a so-called auxiliary unit gear box of a gas turbine engine.

Axes of the drive shafts of the auxiliary units, also referred to as auxiliary unit gear box shafts, run axially parallel to one another and the auxiliary units are positioned inside the gas turbine engine or on the engine next to one another in a manner distributed substantially in the circumferential direction of the gas turbine engine. The gear wheels connected to the auxiliary unit shafts are formed as so-called axially parallel spur gears. The gear wheels are driven by a drive shaft connected to the engine shaft preferably by way of further gear wheels of the operative connection that are part of a bevel gear toothing. In this case, the axes of the drive shafts, which are respectively connected to an axially parallel spur gear for rotation therewith and the axially parallel spur gears of which intermesh, run parallel to one another.

The previously described configuration of the gear wheels connected to the auxiliary unit shafts as axially parallel spur gears and the associated axially parallel arrangement of the drive shafts of the auxiliary units are however the reason for the auxiliary unit gear box being characterized by a high installation space requirement and also having a high dead weight. This results from the fact that, for the arrangement of the auxiliary units next to one another in the circumferential direction of a gas turbine engine, in each case a great distance between the axes of the drive shafts or the auxiliary unit shafts has to be bridged, for which reason the axially parallel spur gears have large dimensions and a high dead weight.

The present disclosure is based on the object of providing a gas turbine engine for an aircraft that is characterized both by small outer dimensions and by a low dead weight.

According to a first aspect, a gas turbine engine for an aircraft with an engine shaft that is in operative connection with auxiliary units is provided. The operative connection comprises interengaging gear wheels. At least one gear wheel of the operative connection is configured as a beveloid gear wheel.

On account of the use of at least one beveloid gear wheel, which can be brought into engagement with axially parallel spur gears and beveloid gear wheels, it is easily possible to arrange the auxiliary units with great flexibility such that they are adapted to the installation space respectively present inside the gas turbine engine, at least partially inside and outside the gas turbine engine or outside the gas turbine engine, for example in the region of a pylon. A pylon is understood in the present case as meaning an aerodynamically optimized connecting region of a gas turbine engine to an aircraft.

As a result of the flexible arrangement of the auxiliary units spatially in relation to one another, the installation space respectively available inside and/or outside a gas turbine engine can be used and a gas turbine engine can be formed in a manner optimized in terms of the installation space. In this way, the gas turbine engine can be configured in the desired way as lightweight and with small outer dimensions, and an aircraft can be operated with low consumption.

The at least one beveloid gear wheel used to create the most flexible possible arrangement of the auxiliary units in relation to one another does not cause any additional production costs in comparison with the axially parallel spur gears used in practice in the field of auxiliary unit gear boxes, whereby the previously described configuration of the gas turbine engine is furthermore also cost-neutral in comparison with the conventional solutions. The low production costs result from the fact that beveloid gear wheels can be produced with the same tools and machines as axially parallel spur gears.

In the case of the gear wheels of the operative connection respectively formed in the present case as a beveloid gear wheel, an angle between axes is implemented by changing the addendum modification, while at the same time the module over the width of the tooth face is constant.

According to one aspect of the present disclosure, at least one gear wheel of the operative connection is connected to the engine shaft for rotation therewith and is configured as an axially parallel spur gear, as a beveloid gear wheel or as a bevel gear. Furthermore, the gear wheel may mesh with a further gear wheel of the operative connection that is formed as an axially parallel spur gear, as a beveloid gear wheel or as a bevel gear. In this way, it is once again easily possible to implement any desired degree of flexibility of the arrangement of the auxiliary units inside a respectively available installation space.

In the case of a further embodiment of the gas turbine engine, to implement a high degree of flexibility of the arrangement, it is provided that at least one gear wheel of the operative connection is connected to a drive shaft of an auxiliary unit for rotation therewith, is configured as an axially parallel spur gear, as a beveloid gear wheel or as a bevel gear and meshes with a further gear wheel of the operative connection that is formed as an axially parallel spur gear, as a beveloid gear wheel or as a bevel gear.

In the case of a further embodiment of the gas turbine engine that is characterized by a high degree of flexibility of the arrangement of the auxiliary units inside the installation space respectively present, at least one gear wheel of the operative connection is connected for rotation therewith to an auxiliary shaft running substantially in the radial direction of the gas turbine engine and outwardly from the engine shaft. It is additionally provided that the gear wheel is formed as an axially parallel spur gear, as a beveloid gear wheel or as a bevel gear and meshes with a further gear wheel of the operative connection that is formed as an axially parallel spur gear, as a beveloid gear wheel or as a bevel gear.

According to a further aspect of the present disclosure, at least one gear wheel of the operative connection is connected for rotation therewith to a coupling shaft running from the auxiliary shaft substantially in the axial direction of the gas turbine engine and is formed as an axially parallel spur gear, as a beveloid gear wheel or as a bevel gear. Furthermore, it is provided that the gear wheel meshes with a further gear wheel of the operative connection that is formed as an axially parallel spur gear, as a beveloid gear wheel or as a bevel gear. In this way it is once again easily possible to arrange the auxiliary units with a high degree of freedom in the installation space present.

According to a further aspect, at least one axis of a drive shaft of one auxiliary unit forms an acute angle with an axis of a drive shaft of a further auxiliary unit. As a result of the angular arrangement of at least two drive shafts, and consequently also the associated auxiliary units, the auxiliary units can be arranged spatially in relation to one another in a manner optimized in terms of the installation space in a structurally easy way. Furthermore, the angular arrangement of the auxiliary units in relation to one another offers the possibility of configuring the gear wheels that are respectively connected to the drive shafts for rotation therewith with a smaller diameter, and consequently also forming an auxiliary unit gear box comprising the gear wheels more favorably in terms of installation space and with a lower dead weight. In this way, the gas turbine engine itself can likewise be configured as more lightweight and with smaller dimensions. This is possible because, as a result of the angular arrangement of the auxiliary units or their drive shafts a smaller axial distance has to be bridged in the region of the tooth engagements between the gear wheels than is the case with a parallel arrangement of the drive shafts and the auxiliary units in relation to one another.

If at least one axially parallel spur gear or a beveloid gear wheel is respectively provided as an intermediate wheel between two gear wheels in each case of the operative connection, which are configured as an axially parallel spur gear or a beveloid gear wheel, the auxiliary units can be easily arranged such that they are adapted to the installation space available in the gas turbine engine or on the gas turbine engine and in a manner that is favorable in terms of installation space.

If the axes of the drive shafts of the auxiliary units define a plane, the auxiliary units can be arranged in relation to one another favorably in terms of installation space in the manner of a flat, spread-out fan.

In the case of a further embodiment of the gas turbine engine that is favorable in terms of installation space, a number of gear wheels of the operative connection that are configured as beveloid gear wheels or as axially parallel spur gears and are respectively connected to a drive shaft of an auxiliary unit for rotation therewith are simultaneously in engagement with a gear wheel of a drive shaft configured as an axially parallel spur gear or as a beveloid gear wheel. In this case, it may also be provided that gear wheels of the drive shafts of the auxiliary units that are not in engagement with the central gear wheel respectively mesh with a gear wheel of a drive shaft of an auxiliary unit or with an intermediate wheel that is in operative connection with the central gear wheel.

In the case of an embodiment of the gas turbine engine that is likewise favorable in terms of installation space, the axes of the drive shafts of the auxiliary units define a lateral surface of a cone. In this case, there is the possibility that the axes of the drive shaft of the auxiliary units lie on a lateral surface of a right or oblique circular cone or of an elliptic cone.

If at least two intermeshing gear wheels of drive shafts of two auxiliary units have different numbers of teeth than one another, the auxiliary units can be operated at different rotational speeds.

If the auxiliary units are in each case arranged on the same side of the gear wheels that are respectively connected to the drive shafts of the auxiliary units, once again an arrangement of the auxiliary units that is adapted to the available installation space in the gas turbine engine and/or on the gas turbine engine can be implemented with a high degree of flexibility.

In an alternative embodiment of the gas turbine engine to this, in which the auxiliary units can likewise be adaptively arranged to the desired extent to an available installation space in the gas turbine engine and/or on the gas turbine engine, at least one auxiliary unit is arranged on one side of the gear wheels that are connected to the drive shafts of the auxiliary units and at least one further auxiliary unit is positioned on the side of the gear wheels opposite thereto.

It is understandable to a person skilled in the art that a feature or parameter described in relation to one of the above aspects may be applied to any other aspect, unless they are mutually exclusive. Furthermore, any feature or any parameter described here may be applied to any aspect and/or combined with any other feature or parameter described here, unless they are mutually exclusive.

Embodiments will now be described by way of example with reference to the figures, in which:

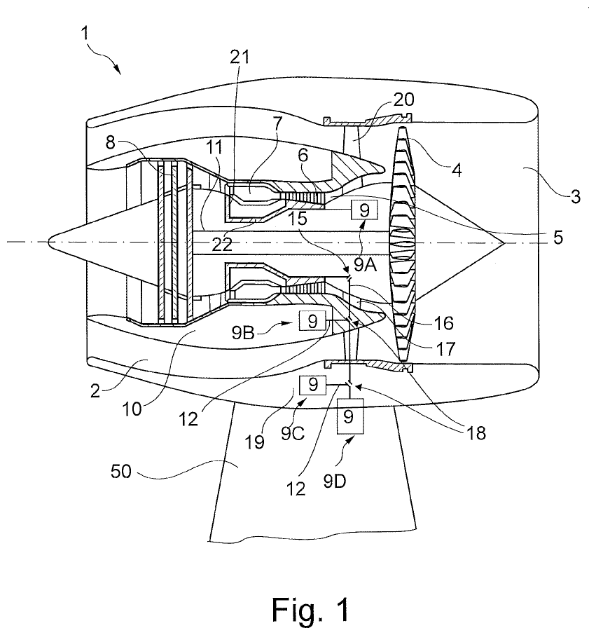

FIG. 1 shows a highly schematized longitudinal sectional view of a gas turbine engine with various operative connections between an engine shaft and auxiliary units of the gas turbine engine;

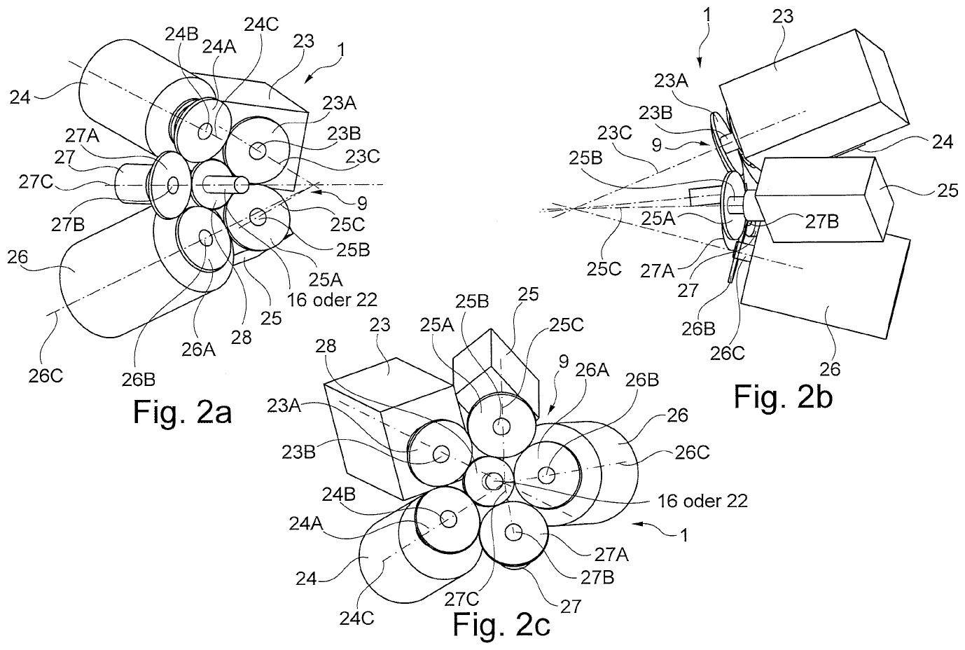

FIG. 2a to FIG. 2c respectively show a three-dimensional individual view of a first embodiment of an auxiliary unit gear box of the operative connection of the gas turbine engine according to FIG. 1;

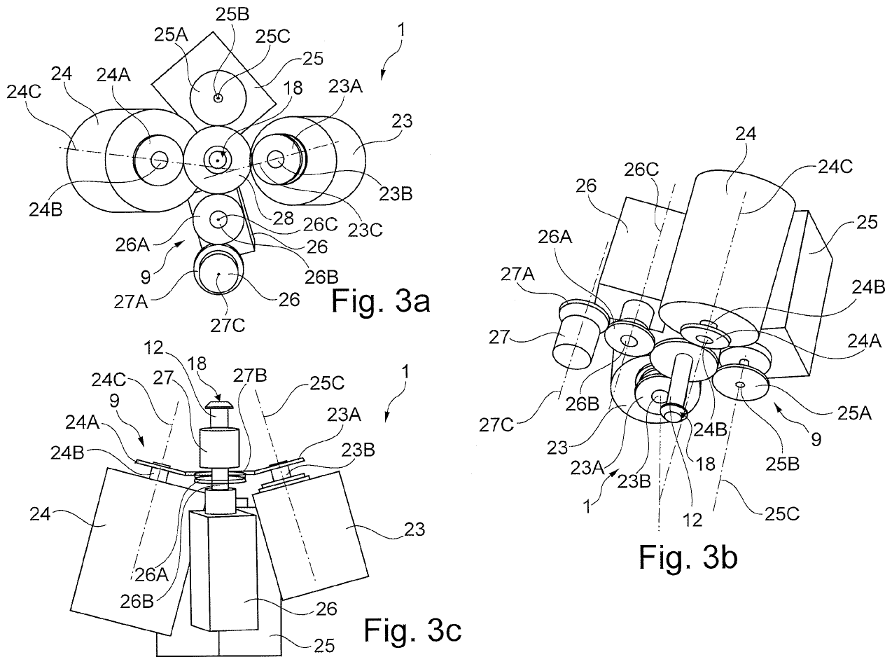

FIG. 3a to FIG. 3c respectively show a three-dimensional individual view of a further embodiment of the auxiliary unit gear box of the gas turbine engine according to FIG. 1;

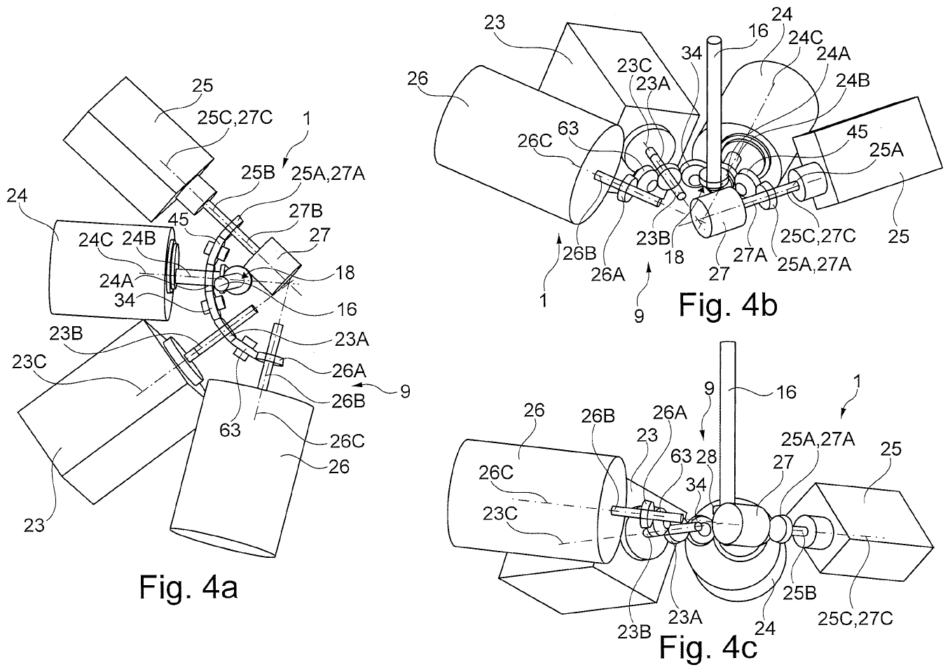

FIG. 4a to FIG. 4c respectively show a three-dimensional individual view of a further embodiment of the auxiliary unit gear box of the gas turbine engine according to FIG. 1; and

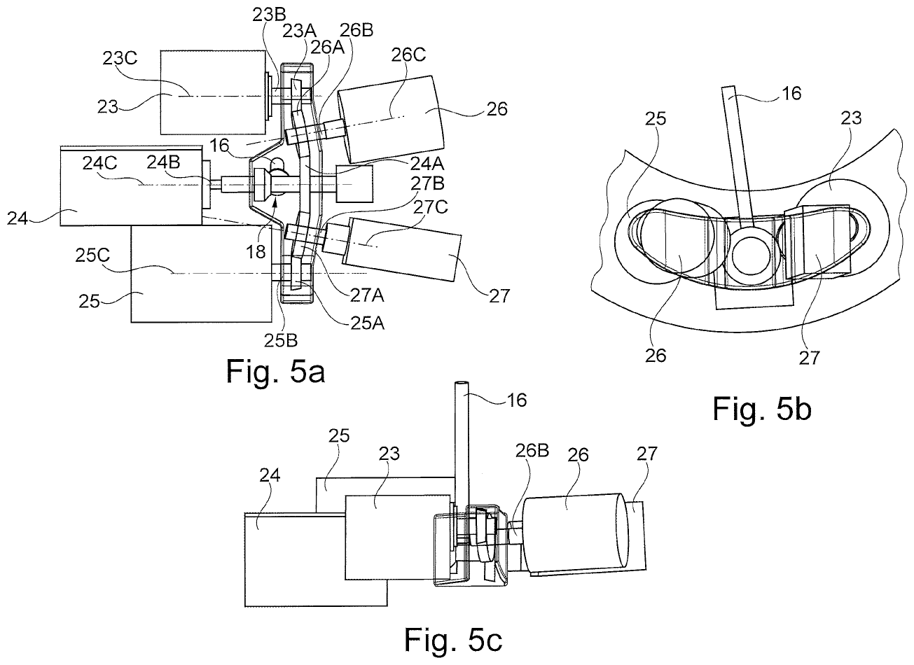

FIG. 5a to FIG. 5c respectively show a two-dimensional individual view of a further embodiment of the auxiliary unit gear box of the gas turbine engine according to FIG. 1.

FIG. 1 shows a longitudinal sectional view of a gas turbine engine 1, which has a bypass flow channel 2 and an intake region 3. In a way that is known per se, the intake region 3 is adjoined downstream by a fan 4. Downstream in turn from the fan 4, the flow of fluid in the gas turbine engine 1 splits into a bypass flow B and a core flow A. The bypass flow B flows through the bypass flow channel 2 and the core flow A flows into an engine core 5. Once again in a way that is known per se, the engine core 5 is configured with a compressor device 6, a burner 7, a low-pressure turbine 8, intended for driving the fan 4, and a high-pressure turbine 21, intended for driving the compressor device 6. The high-pressure turbine 21 and the compressor device 6 are connected to one another by way of an engine shaft or a high-pressure shaft 22.

Furthermore, the gas turbine engine 1 is formed with an auxiliary unit gear box 9 and auxiliary units 23 to 27, which are respectively shown more specifically in FIG. 2a to FIG. 5c and can likewise be driven by the engine shaft 22 by way of a corresponding operative connection. Shown here in FIG. 2a to FIG. 5c are various embodiments of the auxiliary unit gear box 9 and arrangements of the auxiliary units 23 to 27 in relation to one another and also different configurations of the operative connection between the engine shaft 22 and the auxiliary units 23 to 27. The various configurations make it possible to arrange the auxiliary unit gear box 9 and also the auxiliary units 23 to 27 in regions 9A to 9D inside and/or outside the gas turbine engine 1.

The regions 9A to 9C are arranged inside the gas turbine engine 1, while the region 9D lies only partly inside the gas turbine engine and partly outside the gas turbine engine 1, or may also lie completely outside the gas turbine engine 1. There is also the possibility that the region 9D lies partly or completely inside a pylon 50, by way of which the gas turbine engine 1 is attached in a way known per se to an aircraft not shown any more specifically.

If the operative connection and the auxiliary unit gear box 9 are configured in the manner shown in FIG. 2a to FIG. 2c, it is easily possible to arrange the structural unit comprising the auxiliary unit gear box 9 and the auxiliary units 23 to 27 in the region 9A or in the region 9D.

A configuration of the auxiliary unit gear box 9 and of the operative connection respectively corresponding to FIG. 3a to FIG. 3c, FIG. 4a to FIG. 4c and FIG. 5a to FIG. 5c makes it easily possible to arrange the auxiliary unit gear box 9 and the auxiliary units 23 to 27 in the region 9B inside an intermediate housing 10 of the gas turbine engine 1 or in the region 9C inside a housing 19 arranged outside the bypass flow channel 2 or an engine nacelle. Seen in the radial direction of the gas turbine engine 1, the intermediate housing 10 is located in a region between the engine core 5 and the bypass flow channel 2.

For driving the auxiliary unit gear box 9 according to FIG. 2a to FIG. 2c, there is the possibility of configuring a gear wheel 28 of the operative connection as a beveloid gear wheel or as an axially parallel spur gear, with which gear wheels 23A to 27A of the auxiliary unit gear box 9 mesh. The gear wheels 23A to 27A are then not in engagement with one another. If the gear wheel is formed as a beveloid gear wheel, there is the possibility of forming all of the gear wheels 23A to 27A as axially parallel spur gears, some as axially parallel spur gears and some as beveloid gear wheels or all as beveloid gear wheels. Axes 23C to 27C of drive shafts 23B to 27B of the auxiliary units 23 to 27 and the auxiliary units 23 to 27 can then be arranged to the extent shown at an angle to one another in the region 9A and around the engine shaft 11 or in the region 9D. As shown, the axes 23C to 27C of the drive shafts 23B to 27B may lie on a lateral surface of a right circular cone.

In the case of an arrangement of the auxiliary unit gear box 9 and the auxiliary units 23 to 27 in the region 9A, the gear wheel 28 is connected directly to the engine shaft 22 with a configuration that is favorable in terms of installation space. As a difference from this, in the case of an arrangement of the auxiliary unit gear box 9 and the auxiliary units 23 to 27 in the region 9D, the gear wheel 28 is connected for rotation therewith to an auxiliary shaft 16 running outward in the radial direction of the gas turbine engine 1 from the engine shaft 22 through an inner strut 17 and an outer strut 20. The struts 17 and 20 represent in each case a strut formed with a hollow profile, and they lead outward through the engine core 5 to the intermediate housing 10 or through the bypass flow channel 2 into the housing 19. In this case, the auxiliary shaft 16 or the radial drive shaft can be driven by the engine shaft 22 by way of a bevel gear toothing 15, and the auxiliary units 23 to 27 are arranged around an axis of the auxiliary shaft 16.

Independently of this there is also the possibility that only one of the gear wheels 23A to 27A or else more than one of the gear wheels 23A to 27A is or are in engagement with the gear wheel 28. Then, the driving of the gear wheels 23A to 27A that do not mesh with the gear wheel 28 takes place by one of the gear wheels 23A to 27A that is in engagement with the gear wheel 28. In this case, it may also be provided that the drive takes place by way of an intermediate wheel configured as an axially parallel spur gear or as a beveloid gear wheel, if this is required for reasons of installation space.

If the auxiliary unit gear box 9 is formed according to FIG. 3a to FIG. 3c, according to FIG. 4a to FIG. 4c or according to FIG. 5a to FIG. 5c, the auxiliary shaft 16 only runs radially outward as far as the intermediate housing 10 or as far as the engine nacelle 19. In the case of the configuration of the auxiliary unit gear box 9 according to FIG. 3a to FIG. 3c, the auxiliary shaft 16 is in operative connection with a coupling shaft 12 running substantially in the axial direction of the gas turbine engine 1 by way of a further bevel gear toothing 18. The coupling shaft 12 is connected for rotation therewith to the gear wheel 28, which once again may be formed as an axially parallel spur gear or as a beveloid gear wheel.

Depending on the particular application concerned and the installation space available in each case, there is the possibility that only the gear wheels 23A and 24A are configured as beveloid gear wheels, while the drive wheels 25A to 27A are formed as spur gears. The drive wheels 23A to 26A once again all mesh with the central gear wheel 28, while the drive wheel 27A is only in engagement with, and can be driven by, the drive wheel 26A. The drive shafts 23B and 24B of the auxiliary units 23 and 24 respectively form an angle with the drive shafts 25B to 27B of the auxiliary units 25 to 27, in order to be able to configure the arrangement comprising the auxiliary unit gear box 9 and the auxiliary units 23 to 27 favorably in terms of installation space to the desired extent and in order to be able to use an installation space available in the gas turbine engine 1 and/or outside the gas turbine engine 1 optimally and also in order to be able to configure the auxiliary unit gear box 9 with a low dead weight.

In the case of the configuration of the auxiliary unit gear box 9 according to FIG. 4a to FIG. 4c, the drive wheels 23A to 27A are configured as beveloid gear wheels. In the present case, the gear wheels 25A and 27A and the drive shafts 25B and 27B of the auxiliary units 25 and 27 are configured in one piece. This means that the auxiliary unit 25 and the auxiliary unit 27 have a common drive shaft and also a common gear wheel. Furthermore, the drive shaft 24B is in operative connection with the auxiliary shaft 16 by way of the bevel gear toothing 18, and consequently assumes the function of the coupling shaft 12.

Between the gear wheels 26A and 23A or 23A and 24A or 24A and 25A, an intermediate wheel 45 or 34 or 63 is respectively provided. The intermediate wheels 45, 34 and 63 are configured as axially parallel spur gears and may also be formed as beveloid gear wheels. The axes 23C to 26C of the drive shafts 23B to 26B lie in one plane and form defined angles with one another. On account of the auxiliary units 23 to 27 therefore being arranged in relation to one another substantially in the form of a fan, the arrangement shown in FIG. 4a to FIG. 4c, consisting of the gear wheels 23A to 26A, the drive shafts 23B to 26B and the auxiliary units 23 to 27, is configured favorably in terms of installation space and with a low dead weight.

A further configuration of the auxiliary unit gear box 9, and an associated arrangement of the auxiliary units 23 to 27 in relation to one another are shown in turn by FIG. 5a to FIG. 5c. As a difference from the previously described arrangements of the auxiliary units 23 to 27, in which the auxiliary units 23 to 27 are respectively arranged substantially on one side of the gear wheels 23A to 27A, in the case of the configuration of the auxiliary unit gear box 9 according to FIG. 5a to FIG. 5c the auxiliary units 23 to 25 are arranged on one side of the gear wheels 23A to 27A.

The auxiliary units 26 and 27 are positioned on the side of the gear wheels 23A to 27A opposite thereto. The gear wheels 23A, 24A and 25A are once again configured as beveloid gear wheels, while the gear wheels 26A and 27A are formed as axially parallel spur gears. This configuration of the gear wheels 23A to 27A once again offers the possibility of arranging the drive shafts 26B and 27B at an angle in relation to one another, while the drive shafts 23B to 25B run substantially parallel to one another, and consequently can be arranged such that they are optimally adapted to the desired extent to the installation space available in the gas turbine engine 1 and/or outside the gas turbine engine 1.

The configuration of the gear wheels 23A to 27A makes it possible in a structurally easy and low-cost way to create angles within a range of values greater than zero degrees and up to approximately 20 degrees between the axes 23C to 27C of the drive shafts 23B to 27B. In this case, the production costs are approximately equal to the production costs incurred for the production of auxiliary unit gear boxes that are configured with spur gears, causing a considerably greater installation space requirement. This results from the fact that beveloid gear wheels can in principle be produced with the same tools and machines as are used during the production of spur gears.

The angular arrangement of the auxiliary units means that they can be integrated favorably in terms of installation space in existing installation spaces inside and/or outside a gas turbine engine, with at the same time a low dead weight of the drive wheels. Here there is also the possibility, as previously explained in more detail, of arranging at least some of the auxiliary units in a pylon that is provided in a region of attachment between an aircraft and the gas turbine engine.

In addition, by differing configuration of the gear wheels 23A to 27A, the angles between the individual axes 23C to 27C of the drive shafts 23B to 27B of the auxiliary units 23 to 27 are easily variable according to requirements. This provides the possibility of setting or adapting the arrangement of the auxiliary units 23 to 27 in relation to one another optimally to the desired extent to the respectively available installation space in the gas turbine engine and/or outside the gas turbine engine.

### LIST OF REFERENCE SIGNS

1 Gas turbine engine
2 Bypass flow channel
3 Intake region
4 Fan
5 Engine core
6 Compressor device
7 Burner
8 Low-pressure turbine
9 Auxiliary unit gear box
10 Intermediate housing
11 Engine shaft
12 Coupling shaft
15 Bevel gear toothing
16 Auxiliary shaft
17 Inner strut
18 Bevel gear toothing
19 Housing
20 Outer strut
21 High-pressure turbine
22 Engine shaft, high-pressure shaft
23 Auxiliary unit
23A Gear wheel
23B Drive shaft
23C Axis
24 Auxiliary unit
24A Gear wheel
24B Drive shaft
24C Axis
25 Auxiliary unit
25A Gear wheel
25B Drive shaft
25C Axis
26 Auxiliary unit
26A Gear wheel
26B Drive shaft
26C Axis
27 Auxiliary unit
27A Gear wheel
27B Drive shaft
27C Axis
28 Gear wheel
34 Intermediate wheel
45 Intermediate wheel
50 Pylon
63 Intermediate wheel

1. A gas turbine engine for aircraft with an engine shaft, which is in operative connection with auxiliary units, the operative connection comprising interengaging gear wheels and at least one of the gear wheels of the operative connection being configured as a beveloid gear wheel.

2. The gas turbine engine according to claim 1, wherein at least one gear wheel of the operative connection is connected to the engine shaft for rotation therewith, is configured as an axially parallel spur gear, as a beveloid gear wheel or as a bevel gear and meshes with a further gear wheel of the operative connection that is formed as an axially parallel spur gear, as a beveloid gear wheel or as a bevel gear.

3. The gas turbine engine according to claim 1, wherein at least one gear wheel of the operative connection is connected to a drive shaft of an auxiliary unit for rotation therewith, is configured as an axially parallel spur gear, as a beveloid gear wheel or as a bevel gear and meshes with a further gear wheel of the operative connection that is formed as an axially parallel spur gear, as a beveloid gear wheel or as a bevel gear.

4. The gas turbine engine according to claim 1, wherein at least one gear wheel of the operative connection is connected for rotation therewith to an auxiliary shaft running substantially in the radial direction of the gas turbine engine and outwardly from the engine shaft, is formed as an axially parallel spur gear, as a beveloid gear wheel or as a bevel gear and meshes with a further gear wheel of the operative connection that is formed as an axially parallel spur gear, as a beveloid gear wheel or as a bevel gear.

5. The gas turbine engine according to claim 4, wherein at least one gear wheel of the operative connection is connected for rotation therewith to a coupling shaft running from the auxiliary shaft substantially in the axial direction of the gas turbine engine, is formed as an axially parallel spur gear, as a beveloid gear wheel or as a bevel gear and meshes with a further gear wheel of the operative connection that is formed as an axially parallel spur gear, as a beveloid gear wheel or as a bevel gear.

6. The gas turbine engine according to claim 1, wherein at least one axis of a drive shaft of an auxiliary unit forms an acute angle with an axis of a drive shaft of a further auxiliary unit.

7. The gas turbine engine according to claim 1, wherein an axially parallel spur gear or a beveloid gear wheel is provided as an intermediate wheel between two gear wheels in each case of the operative connection, which are respectively configured as an axially parallel spur gear or a beveloid gear wheel.

8. The gas turbine engine according to claim 1, wherein the axes of the drive shafts of the auxiliary units lie in a common plane.

9. The gas turbine engine according to claim 1, wherein a number of gear wheels of the operative connection that are configured as beveloid gear wheels or as axially parallel spur gears and are respectively connected to a drive shaft of an auxiliary unit for rotation therewith are simultaneously in engagement with a further gear wheel of the operative connection that is connected to a drive shaft of an auxiliary unit for rotation therewith and is configured as an axially parallel spur gear or as a beveloid gear wheel.

10. The gas turbine engine according to claim 9, wherein the axes of the drive shafts of the auxiliary units define a lateral surface of a cone.

11. The gas turbine engine according to claim 1, wherein at least two intermeshing gear wheels have different numbers of teeth than one another.

12. The gas turbine engine according to claim 1, wherein the auxiliary units are in each case arranged on the same side of the gear wheels of the operative connection that are connected to the drive shafts of the auxiliary units.

13. The gas turbine engine according to claim 1, wherein at least one auxiliary unit is arranged on one side of the gear wheels of the operative connection that are connected to the drive shafts of the auxiliary units and at least one further auxiliary unit is positioned on the side of the gear wheels opposite thereto.
